(19) United States
(12) Patent Application Publication
(10) Pub. No.: US 2013/0062023 A1
(43) Pub. Date: Mar. 14, 2013

(54) WINDOW SYSTEM

(71) Applicant: Lauren Little, Seattle, WA (US)

(72) Inventor: Lauren Little, Seattle, WA (US)

(21) Appl. No.: 13/618,142

(22) Filed: Sep. 14, 2012

Related U.S. Application Data
(60) Provisional application No. 61/534,819, filed on Sep. 14, 2011.

(51) Int. Cl. E06B 3/50

(52) U.S. Cl. 160/109; 160/323.1

(57) ABSTRACT

A window covering system includes a window blind and a pet curtain. The window blind has an upper region and a lower region. The upper region is coupled to a window frame such that the window blind hangs from the window frame. The pet curtain is coupled to the window blind and extends downwardly past a lower region of the window blind towards a lower portion of the window frame. At least a portion of a dog or cat can move past the pet curtain of the window system to view out of the window without raising the window blinds. The pet curtain includes pass-through features that allow the pet to pass therethrough and that can move back into position after the pet has passed therethrough to substantially cover the window frame or that can be removed from the curtain or reattached to the curtain.

### BACKGROUND

1. Technical Field

The present invention relates generally to window systems and methods of using and installing the same. More specifically, the invention relates to window treatment systems through which at least a portion of an animal can pass through a pet curtain.

2. Description of the Related Art

Traditional residential window blinds are capable of covering an entire window frame or a portion of the window frame depending upon the needs of a resident and the amount of light desired from outside the residence. It is common for residents with indoor pets to partially raise the window blind so that pets, such as dogs and cats, can sit on or by the window sill. Raising the window blinds for this purpose, however, may cause concerns over privacy, safety, and the amount of light entering the residence. Alternatively, residents will completely lower the window blinds to cover the entire window frame and pets will continuously walk or sit behind the window blinds to view out the window, thereby causing damage to the window blinds. Therefore, it is desirable to include a pet curtain that obviates at least some or all of the aforementioned concerns.

### BRIEF SUMMARY

At least some embodiments are directed to a window system having one or more pass-through curtains for pets to pass therethrough. Pets can easily move through the curtains to view out a window without damaging window blinds. The curtain can include one or more pass-through access features. The access features can include, but are not limited to, slits, flaps, and/or foldable portions or sections. In certain embodiments, the window system can cover substantially the entire window and includes two different types of coverings, such as window blinds, curtains, shades, or the like.

The window system, in some embodiments, can block light and can also prevent people outside of a dwelling from seeing inside the dwelling. Dogs, cats, or other pets can pass through the curtain while maintaining privacy because curtains tend to close behind the animal to ensure that privacy is maintained. If the window system includes a window blind and a curtain, the curtain may be removed from the blind. When desired, the window blind can be moved to a partially raised configuration, and the curtain can be coupled again to the partially raised window blind.

In some embodiments, a window treatment system includes a curtain hanging from a window blind. A pet can sit between the curtain and the window and can pass through the curtain to the interior of a dwelling. Couplers can couple the top of the curtain to the window blind. The couplers can be rigid, hard couplers made, in whole or in part, of metal, plastic, combinations thereof, or the like. In other embodiments, the couplers are soft and made, in whole or in part, of fabric, adhesive, hook and loop type fastener, and can include one or more clips, hooks, and the like.

The curtain can have one or more slits which a pet can access to look out the window. Additionally or alternatively, the curtain can have overlapping panels that lay against one another. A pet can move between the panels. In other embodiments, couples, (e.g., fasteners) can hold rolled up or folded sections of the curtain.

To install a window treatment system, a window blind can be raised to a desired position. A user can couple a curtain to the partially raised window blind until the bottom of the curtain rests on or is positioned slightly above the window sill. Pets can conveniently pass through the curtain to view out the window without damaging the blinds. The bottom of the blinds can be spaced apart from the window sill a sufficient distance to ensure that the window blinds are not contacted or damaged.

A window covering system, in some embodiments, comprises a window blind and a curtain. The window blind has an upper region and a lower region. The upper region is coupled to a window frame. The window blind hangs from the window frame. The curtain is coupled to the window blind and extends downwardly past a lower region of the window blind towards a lower portion of the window frame, such as a window sill.

A window blind, in some embodiments, is movable between a raised position and a lowered position while a curtain remains coupled to a window blind. A user can lower the window blind until the curtain touches or is slightly spaced apart from the window sill. The curtain can have a plurality of pass-through features. A pet's head, paws, entire body, or the like can move through the pass-through features. The pet can be, for example, a large pet (e.g., a St. Bernard), a medium size pet (e.g., a Golden Retriever), or a small pet (e.g., a Chihuahuas).

The curtain can have a non-access configuration to obstruct the window and an access configuration defining an access opening to the window. In some embodiments, the curtain in the access configuration has a folded sector or rolled-up section that defines a pass-through opening. In the non-access configuration, the curtain can hang down and block most or substantially all of a gap between the window blind and the window sill.

In yet other embodiments, a method comprises positioning a lower portion of a window blind to be spaced apart from a lower section of the window frame and installing an access curtain such that the access curtain extends across most of a gap between the window blind and the lower section of the window frame. The access curtain includes at least one pass through feature through which a pet is capable of passing therethrough. The access curtain can allow normal function of the blind. By way of example, the slats of the blind can be rotated, the blind can be raised, or combinations thereof. The method may further comprise covering the gap with the access curtain by hanging the curtain on the lower portion of the window blind. The method may further comprise positioning the window blind such that at least a portion of dog or a cat is capable of traveling past the access curtain without damaging the window blind. The method may further comprise coupling the access curtain directly to the window bind.

### BRIEF DESCRIPTION OF THE SEVERAL VIEWS OF THE DRAWINGS

Non-limiting and non-exhaustive embodiments are described with reference to the following drawings. The same reference numerals refer to like parts throughout the various views, unless otherwise specified.

FIG. 1 is a rear elevational view of an installed window system, in accordance with one embodiment.

FIG. 2 is a front elevational view of the window system of FIG. 1.

FIG. 3 is an elevational view of a window system ready to be installed, in accordance with one embodiment.

FIG. 4 is an elevational view of the window system of FIG. 3 in an installed state.

FIG. 5 is an elevational view of a window system ready for installation.

FIG. 6 is an elevational view of a curtain carried by a bottom rail or rod.

FIG. 7 is a side elevational view of a window system, in accordance with one embodiment.

FIG. 8 is a side elevational view of a window system, in accordance with another embodiment.

FIG. 9 is an isometric view of a portion of a window treatment system ready to be assembled.

FIG. 10 is a front elevational view of a portion of a window treatment system.

FIG. 11 is a front elevational view of a portion of a window treatment system, in accordance with yet another embodiment.

FIG. 12 is a side elevational view of a portion of a window treatment ready to be assembled.

FIG. 13 is a side elevational view of a window treatment system, in accordance with another embodiment.

FIGS. 14-20B are elevational views of curtains, in accordance with various embodiments.

### DETAILED DESCRIPTION

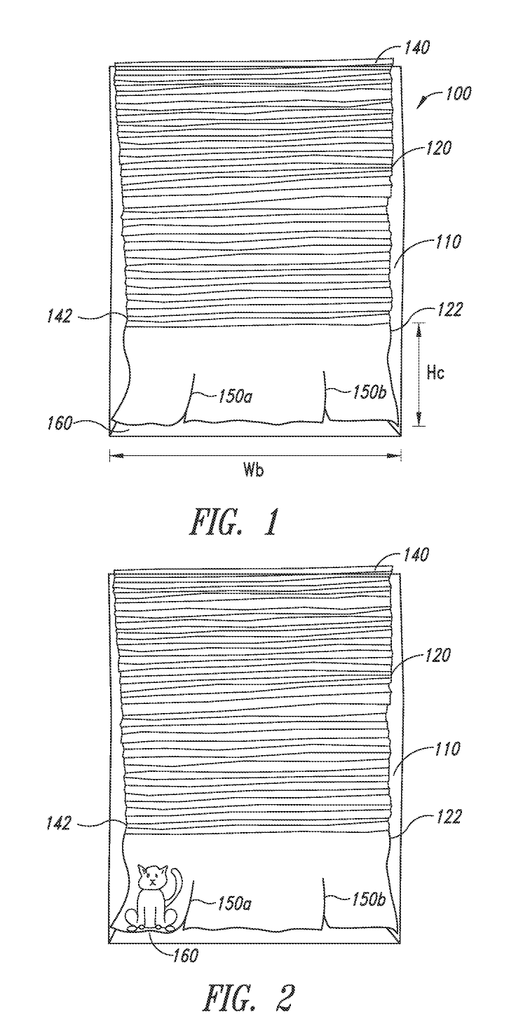

FIG. 1 shows a window treatment system 100 covering a window 110. The window treatment system 100 includes an upper window treatment 120 and a lower window treatment 122. The upper window treatment 120 is in the form of a window blind with vertically spaced apart horizontally-extending slats. The lower window treatment 122 is in the form of a pet pass-through curtain coupled to and hanging from the upper window treatment 120. A pet (e.g., a dog or a cat) on the interior of a dwelling can pass through the curtain 122 to view out of the window, as shown in FIG. 2. Pets can conveniently access and travel along a window sill without damaging the window blind 120.

An upper region 140 (e.g., a mounting structure or bracket) of the window blind 120 is coupled to an upper member or upper region of a window frame. This connection is not shown as it is well known in the art. The curtain 122 can hang from a lower region 142 (e.g., a lower rail or slat) of the window blind 120. The lowermost blind, slat, or rail is spaced apart from the window sill such that pets can move underneath the window blind 120 without, for example, contacting and/or damaging the window blind 120. In some embodiments, including the illustrated embodiment, a pet can travel through access features 150a, 150b, which may be in the form of slits extending upwardly from the bottom of the curtain 122. The curtain 122 can automatically close behind the pet to maintain privacy, as shown in FIG. 2.

Advantageously, the window blind 120 and curtain 122 can cover or obstruct substantially all of the window to prevent light from passing therethrough. The dimensions (e.g., widths, heights, etc.) and configurations of the window blind 120 and curtain 122 can be selected to achieve the desired coverage area. The height of the curtain 122 may be at least about 70%, 80%, or 90% of a height of a gap between the window blind 120 and the window sill. Other heights are also possible, if needed or desired.

The window blind 120 can be venetian blinds or other type of blind through which a cat or dog cannot easily pass. The elongate slats of the window can be made, in whole or in part, of plastic, metal, wood, combinations thereof, or other suitable materials for blocking light. The term “blind” includes, but is not limited to, slat blinds, miniblinds, Persian blinds, venetian blinds, pleated blinds, or the like.

The curtain 122 can be made of a drapable material capable of blocking light. In some embodiments, the curtain 122 is a single piece of material (e.g., fabric). In certain embodiments, the curtain comprises a plurality of separate draperies.

To install the curtain 122, the window blind 120 can be raised to a desired height, such as height Hc, above the window sill such that the curtain 122 extends across most or substantially all of the gap between the bottom of the window blind 120 and a window sill 160. Once the window blind 120 is at a desired height, the curtain 122 can be coupled to the blind 120 to substantially cover a width Wb such that the curtain 122 extends across the length of the gap created by raising the window blind 120. The curtain 122 may be coupled to the window blind 120 using one or more fasteners. The fasteners can include hook and loop type fasteners, adhesives, straps, pins, snaps, or the like. The dimensions and configurations of the curtain 122 can be selected based on the type of pet. For example, the size of the curtain 122 can be increased or decreased to accommodate larger and smaller pets.

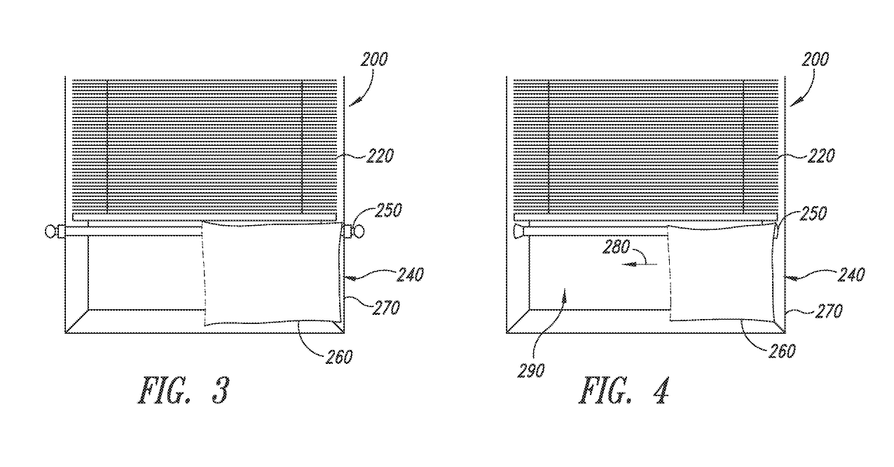

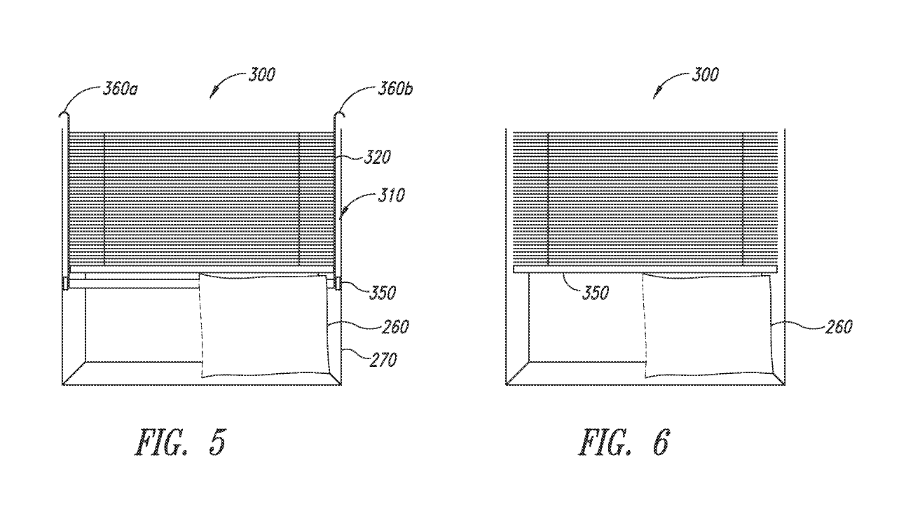

FIG. 3 shows a window treatment system 200 including a window blind 220 and a curtain system 240. The curtain system 240 includes a mounting apparatus 250 and a curtain 260. Advantageously, the mounting apparatus 250 can be installed in a window frame 270 to allow raising and lowering of the blind independent of the position of the curtain. If the mounting apparatus 250 is a tension rod, it can be installed in a wide range of different types of window frames.

As shown in FIG. 4, the mounting apparatus 250 extends between opposing sides of a window frame 270. The curtain 260 may slide along the rod 250, in a direction as indicated by arrow 280, to adjust the size of an access opening 290. In some embodiments, the curtain 260 can be a plurality of separate curtains movable away from one another or adjacent to one another.

FIGS. 5 and 6 show a window treatment system 300 including a mounting system 310 for installing a rod 350. The mounting system 310 includes a pair of hooks 360a, 360b that can be coupled to the top of blinds 320, a window treatment (e.g., valances), the window frame, or the like. In this embodiment, the rod 350 is fixed in place regardless of the height of the window blind 320, which provides the ability to have sunlight enter the through the window while still providing a curtain 260 that remains coupled to rod 350 and slidable thereon.

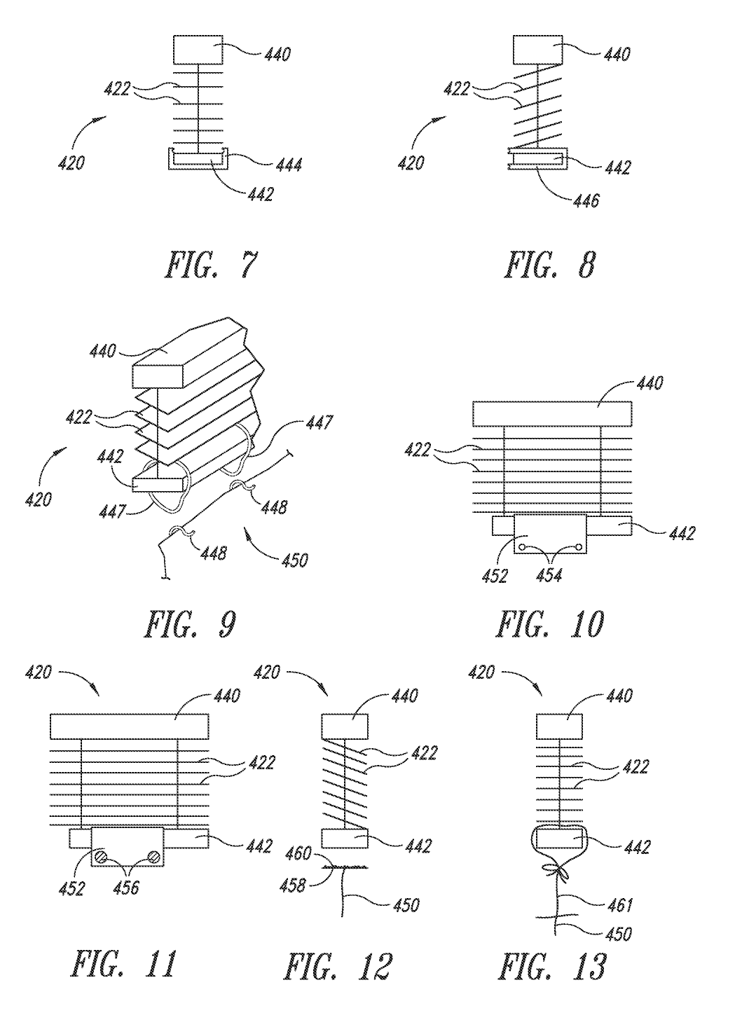

FIGS. 7-13 show different types of mounting arrangements and configurations to couple the curtain 450. FIG. 7 shows a window blind 420 having an upper blind portion 440, slats 422, and a lower blind portion 442. A substantially U-shaped member 444 can be coupled to the lower blind portion 442 and clipped or fastened into place, and any pet curtain described herein may be secured to the U-shaped member 444. FIG. 8 shows a similar embodiment of FIG. 7, but having a substantially C-shaped member 446 that can be slid over the lower blind portion 442 of the window blind 420. Any pet curtain described herein may be secured to the C-shaped member 446. FIG. 9 shows yet another embodiment of the window blind 420 having loops 447 that may be removably coupled to fasteners of curtain 450. The fasteners can include, without limitation, hooks, clamps, or the like, such as loops 447 and hooks 448 attached to curtain 450. FIG. 10 shows a flap 452 that can be coupled to the lower blind portion 442 window blind using fasteners. Any pet curtain described herein may be attached to fasteners 454, which may be snaps or the like. FIG. 11 shows an adhesive 456 (e.g., glue, binders, or the like) for coupling a pet curtain to the lower blind portion 442, similar to FIG. 10. FIG. 12 shows the curtain 450 coupled to the lower blind portion 442 using adhesive 460 coupled to an upper portion of a securing member 458, which is attached to curtain 450. The adhesives described herein may be a pressure-sensitive adhesive, hot melt adhesive, glue, epoxy, combinations thereof, or the like. FIG. 13 shows a flexible member 461 that couples a curtain 450 to a lower blind portion 442 of a window blind 420. The flexible member can be a strip of fabric, an elongate piece of flexible plastic, a piece of yarn or twine, or the like.

FIGS. 14-19 show various curtain configurations that may be attached to a window blind or rod using any of the attachment means described herein. FIG. 14 shows a curtain 600 including access features 610a, 610b, illustrated as slits. The slits extend upwardly away from a bottom of the curtain and provide enough space for a pet to pass therethrough.

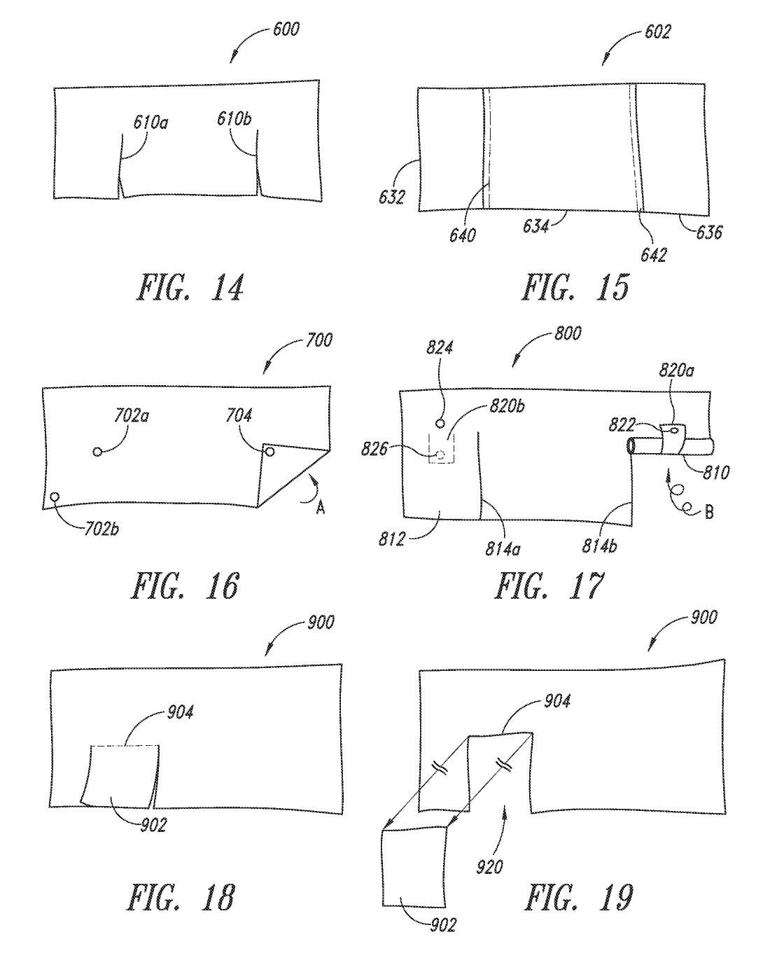

FIG. 15 shows three panels 632, 634, 636 of a curtain 630. Panels 632, 634, 636 hang down to allow convenient passage between overlapping regions 640, 642.

FIG. 16 shows fasteners 702a, 702b, 704 for holding respective corners of the curtain 700. As shown in FIG. 16, a right corner of the curtain 700 is folded back in direction A to form a substantially triangular access opening. Fasteners 702a, 702b, 704 can be snaps, buttons, hook and loop type fastener, or the like.

FIG. 17 shows a curtain 800 including rollable panels 810, 812. Holders 820a, 820b have fasteners 822, 826 for holding rolled panels 810, 812, such as after rolled panel 810 is rolled or folded upwardly about direction B and contained within holder 820a, for example. Although a pet can pass through slits between the panels, the panels 810, 812 can be in a raised configuration for convenient passage.

FIGS. 18 and 19 show a curtain 900 with a removable panel 902. The removable panel 902 can be removed from a removable attachment device 904 to define an access opening 920. The attachment portion 904 may be any suitable removable attachment device discussed herein or known in the art.

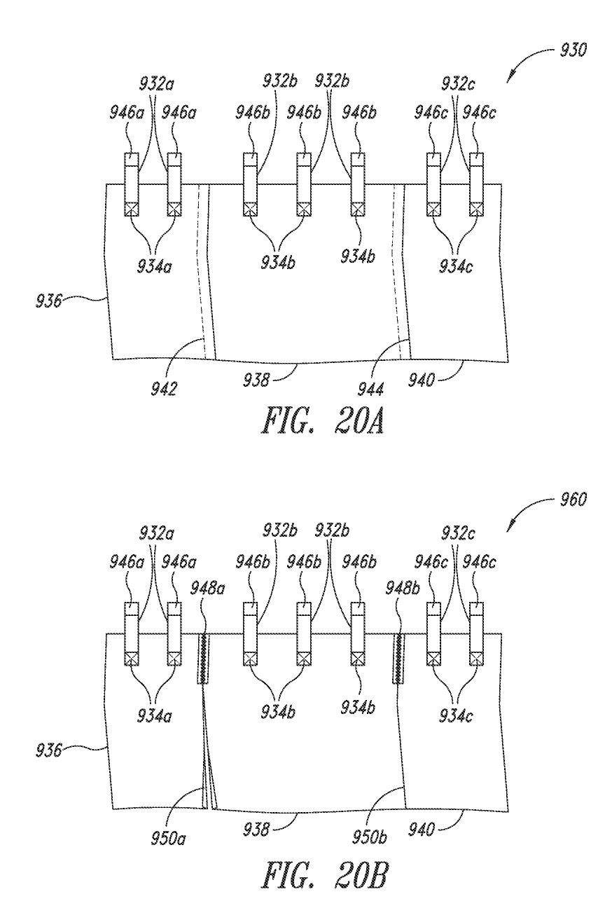

FIG. 20A shows a curtain 930 having a plurality of attachment devices 932a, 932b, 932c coupled to respective panels 936, 938, 940 by a plurality of seams 934a, 934b, 934c, for example. The attachment devices 932a, 932b, 932c may include couplers 946a, 946b, 946c, which may include any number of couplers or fasteners described above, such as hook and loop type fasteners, adhesive, clips, hooks, buttons, and the like. The attachment devices 932a, 932b, 932c may be coupled, for example, to a curtain rod or window blind, in the same or similar manner such as described above with reference to FIGS. 1-19. Alternatively, the attachment devices 932a, 932b, 932c may be coupled to the curtain through loops or holes in the curtain and then attached to a curtain rod or window blind, for example. Similar to FIG. 15, panels 936, 938, 940 hang down to allow convenient passage between overlapping regions 942, 944.

FIG. 20B shows a curtain 960 (similar to FIG. 20A) having a plurality of attachment devices 932a, 932b, 932c coupled to respective panels 936, 938, 940 by a plurality of seams 934a, 934b, 934c, for example. The attachment devices 932a, 932b, 932c may include couplers 946a, 946b, 946c, which may include any number of couplers or fasteners described above, such as hook and loop type fasteners, adhesive, clips, hooks, buttons, and the like. The attachment devices 932a, 932b, 932c may be coupled, for example, to a curtain rod or window blind, in the same or similar manner such as described above with reference to FIGS. 1-19. Alternatively, the attachment devices 932a, 932b, 932c may be coupled to the curtain through loops or holes in the curtain and then attached to a curtain rod or window blind, for example. Similar to FIG. 20A, panels 936, 938, 940 hang down to allow convenient passage between regions 950a, 950b. The panels 936, 938, 940 may be coupled to each other at respective seam portions 948a, 948a, which may be a flat-fell seam or any other suitable seam. The panels described with reference to FIGS. 1-20A may also be coupled to each other by the same or similar seams as seam portions 948a, 948a.

The curtains described herein can be installed using different types of mounting structures. For example, curtains can be mounted directly to blinds using, for example, one or more fasteners, rods (including adjustable rods, tension rods, etc.), hooks, wires, or the like. Additionally, the various embodiments described above can be combined to provide further embodiments. A curtain can have different types of access features (e.g., slits, rollable panels, foldable panels, or the like) and can be coupled other types of window treatments.

In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A window covering system, comprising:
a window blind having an upper region and a lower region, the upper region coupled to a window frame such that the window blind hangs from the window frame; and
a curtain coupled to the window blind, the curtain extending downwardly past the lower region of the window blind towards a lower portion of the window frame, the curtain including at least one pass through feature through which a pet is capable of passing.

2. The window covering system of claim 1, wherein the window blind is movable between a raised position and a lowered position while the curtain is coupled to the window blind.

3. The window covering system of claim 1, wherein the window blind has slats that are rotatable while the curtain is coupled to the window blind

4. The window covering system of claim 1, wherein the pass-through features include at least one overlapping region between adjacent panels, an elongated slit, and a rollable panel movable between a rolled configuration and an unrolled configuration.

5. The window covering system of claim 1, wherein the curtain has a plurality of vertically extending slits through which at least a portion of a dog or a cat is capable of moving through the curtain.

6. The window covering system of claim 5, wherein the slits are dimensioned to allow an entire body of a dog or cat to pass therethrough.

7. The window covering system of claim 1, wherein the curtain has a non-access configuration to block the window and an access configuration to provide access to a window.

8. The window covering system of claim 7, wherein the curtain in the access configuration has a folded corner and in the non-access configuration hangs freely from the window blind.

9. The window covering system of claim 1, wherein the curtain includes at least one fastener to hold a folded portion of the curtain or to hold a rolled portion of the curtain so as to define a pet access opening.

10. The window covering system of any of claims 1 through 9 wherein the curtain is coupled to the window blind or a curtain rod by a plurality of attachment devices.

11. A method, comprising:
positioning a lower portion of a window blind such that the lower portion is spaced apart from a lower section of a window frame; and
installing an access curtain such that the access curtain extends across most of a gap between the window blind and the lower section of the window frame, the access curtain including at least one pass through feature through which a pet is capable of passing.

12. The method of claim 11, further comprising covering the gap with the access curtain by hanging the curtain on the lower portion of the window blind.

13. The method of claim 11, further comprising positioning the window blind such that at least a portion of dog or a cat is capable of traveling past the access curtain without damaging the window blind.

14. The method of claim 11, wherein installing the access curtain includes coupling the access curtain directly to the window bind by at least one attachment device.

15. A pet curtain for hanging from a lower portion of a window blind covering a window frame, the pet curtain comprising:
the curtain including at least one pass-through feature through which a pet is capable of passing;
the at least one pass-through feature comprising one of an overlapping region between adjacent panels, an elongated slit, a rollable panel movable between a rolled configuration and an unrolled configuration, and a panel that is removably attached to the curtain.

16. The pet curtain of claim 15, wherein the pet curtain has a plurality of vertically extending slits through which at least a portion of a pet is capable of moving through the pet curtain.

17. The pet curtain of claim 16, wherein the slits are dimensioned to allow an entire body of a dog or cat to pass therethrough.

18. The pet curtain of claim 15, wherein the pet curtain has a non-access configuration to block the window and an access configuration to provide access to a window.

19. The pet curtain of claim 16, wherein the pet curtain in the access configuration has a folded corner and in the non-access configuration hangs freely from the window blind.

20. The pet curtain of claim 15, wherein the curtain includes at least one fastener to hold a folded portion of the curtain or to hold a rolled portion of the curtain so as to define a pet access opening.

21. The pet curtain of claim 15, wherein the at least one pass-through feature is in a hanging position before and after the pet passes therethrough such that the pet curtain and the window blind substantially cover the window frame.

22. The pet curtain of any of claims 15 through 21 wherein the pet curtain includes a plurality of attachment devices adapted to couple the pet curtain to the window blind or a curtain rod.
